(19) United States
(12) Patent Application Publication
(10) Pub. No.: US 2017/0251859 A1
(43) Pub. Date: Sep. 7, 2017

(54) TWO-TIER COOKING AND BASTING APPARATUS

(71) Applicant: John Mundt, Modesto, CA (US)

(72) Inventor: John Mundt, Modesto, CA (US)

(21) Appl. No.: 15/448,577

(22) Filed: Mar. 2, 2017

Related U.S. Application Data
(60) Provisional application No. 62/303,239, filed on Mar. 3, 2016.

(51) Int. Cl. A47J 27/13; A47J 36/06; A47J 36/34; A23L 5/10

(52) U.S. Cl. CPC A47J 27/13; A23L 5/10; A47J 36/06; A47J 36/34; A23V 2002/00

(57) ABSTRACT

A cooking apparatus for cooking two food items simultaneously, the second food item being positioned to drip fat or other juices onto a first food item. The apparatus includes a roasting pan having a lid, the pan and lid defining an enclosed cooking space, and the bottom of the roasting pan defining a lower cooking surface for supporting a first meat to be cooked;
an upper cooking surface within the enclosed cooking space for supporting a second meat to be cooked, the upper cooking surface situated directly above the lower cooking surface and comprising a solid surface having perforations sufficiently small so that meat placed on the upper cooking surface does not fall though the perforations while sufficiently large that melted fat from the second meat flows through the perforations; and
a support structure that rests on the bottom of the roasting pan and that supports the upper level cooking surface within the enclosed cooking space, the support structure including vertical legs that straddle the lower cooking surface.

### TECHNICAL FIELD OF THE INVENTION

The present invention relates to a cooking apparatus, and in particular to a two-tier cooking apparatus which allows a first food item on the upper tier and a second food on the lower tier, the food items positioned so that drippings from the first food item on the upper tier drip down onto the second food cooking on the lower tier to baste the second food.

### BACKGROUND OF THE INVENTION

Basting is a common cooking technique that involves pouring juices or melted fat onto a meat during cooking to season the meat and keep it from drying out during the cooking process. For example, when cooking a turkey, some of the most common ways of keeping the meat moist and juicy and giving it a wonderfully golden look is to baste it with juices and liquids that fall during the cooking process from top to bottom. A few of the most common ways to accomplish this by the use of suction turkey basters, brushes, spoons, etc. This process of basting must be repeated several times during cooking. Each time this basting is repeated, an oven door has to be opened in order to access the meat being basted. This manual method requires regular attention and is time- and labor-intensive, so technical innovations have been developed to automate and improve upon this process.

Some prior art basting apparatuses comprise a fat collector located at the base of the cooking pan, together with a pump system to pump the fatty liquid upwards to act as a basting liquid. Such as system is described, for example, in U.S. Pat. No 8,881,644 to Scro II for a “Self-Basting Roasting Oven.” Such an apparatus is complex and involves many parts including tubes, valves and pumps, making it expensive, difficult to install and to clean, and prone to breaking down.

Other prior art automatic basters hold a basting liquid over the cooking meat and release the basting liquid. Example of such configurations can be found in GB 150,556 to Esson for “Improvements in Basting Appliances.” and U.S. Pat. No. 4,061,083 to Calica for an “Automatic Food Roasting and Basting Apparatus.” Such apparatuses require preparing a basting liquid in advance and require regulating the release of the basting liquid during the cooking process. It can be difficult to configure a system to meter the release of the basting liquid so that the liquid dispenses for the duration of the cooking process. Holes that are too small can clog and holes that are too large release the liquid to drain too quickly, so that the liquid is exhausted before the end of the cooking process.

### SUMMARY OF THE INVENTION

An object of the invention to provide a cooking apparatus and method that automatically bastes food being cooked.

A method of cooking comprises placing a first food item on a lower cooking surface within a cooking appliance; placing a second food item on an upper support surface positioned above the lower cooking surface in the cooking appliance; and heating the first food item and the second food item in the cooking appliance so that drippings from the second food item drip down onto the first food item to baste the first food item. For example, some embodiments comprise placing a first meat having a first fat content on a lower cooking surface within a cooking appliance; placing a second meat having a second fat content, higher than the first fat content, on a perforated platform positioned above the lower cooking surface in the cooking appliance; and heating the first meat and the second meat in the cooking appliance so that fat from the second meat drips down onto the first meat to baste the first meat.

A cooking apparatus is provided for cooking two food items simultaneously, one of the food items being positioned to drip onto a first food item. The cooking apparatus includes a perforated upper surface for supporting a second food item and a support for maintaining the perforated surface above a first food item. The support may rest on the first food item, on a surface on which the first food item rest, or elsewhere on a cooking apparatus.

The support may be positioned in any type of cooking apparatus, such as roasting pan, an oven, a barbeque grill, a smoker, or any other food heating device.

For example, some embodiments comprise:

a roasting pan having a lid, the pan and lid defining an enclosed cooking space, and the bottom of the roasting pan defining a lower cooking surface for supporting a first food item to be cooked;

a perforated platform within the enclosed cooking space for supporting a second food item to be cooked, the upper cooking surface situated directly above the lower cooking surface and having perforations sufficiently small so that the second food item placed on the upper cooking surface does not fall though the perforations while sufficiently large that liquids from the second meat flows through the perforations; and

a support structure that supports the upper level cooking surface within the enclosed cooking space.

In some embodiments, the perforated platform is supported at a height that allowed a lid to be places over the cooking apparatus containing the first and second food item. In some embodiments, the upper cooking surface and the food items are not in an enclosed cooking space.

In some embodiments, the first food item comprises a first meat and the second food item comprises a second meat, the second meat having a higher fat content than the first meat. In some embodiments, the support structure including vertical legs that rest on the first food item or that are supported by the roasting pan.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows schematically shows a cooking apparatus;

FIG. 2 shows an example of a perforated platform;

FIG. 3a-3c show favorable configuration of slot-shaped perforations;

FIG. 4a-4c show circular perforations arranged in various patterns;

FIG. 5a-5c show square-shaped perforations arranged in a straight pattern;

FIG. 6 shows a rectangular upper cooking surface;

FIG. 7 shows an ovular upper cooking surface;

FIG. 8A-8F show example of various types of supports for upper surface;

FIG. 9 is a flow chart showing the steps of using a basting system;

FIG. 10 shows schematically a cooking apparatus;

FIGS. 11, 12 and 13 show various cooking apparatuses with a disposable aluminum perforated perforate platform and support for the platform;

FIG. 14 schematically shows a barbecue apparatus;

FIG. 15A shows an example of barbecue grill that can be used with the two-tier cooking and basting device; FIG. 15B shows a turkey in a barbeque grill with a perforated platform supported above the turkey;

FIG. 16A shows another cooking device that includes a perforated platform and supports; FIG. 16B shows a barbeque grill having the device of FIG. 16A positioned on the grill.

FIG. 17 shows a perforated surface positioned above the coals of a barbeque grill;

FIG. 18A-C, 19A-C and 20A-C show examples of use of a cooking apparatus;

FIG. 21 shows a perforated platform that has notches for attaching support legs; and

FIG. 22 shows an example in which the downward protrusions have a bending point to allow adjustment of the length, direction and orientation of the downward protrusions to allow accommodation of the perforated platform above the first food item and within the cooking space.

FIG. 23A shows an oven in which a two-tier cooking and basting device is placed on a turkey; FIG. 23B shows a double oven in which two two-tier cooking and basting devices are placed on two turkeys;

FIG. 24 shows an electric smoker in which a two-tier cooking and basting device is placed on a turkey;

FIG. 25 shows a barrel-type smoker in which a two-tier cooking and basting device is placed on a turkey;

FIG. 26 shows a grill on which a two-tier cooking and basting device is placed on a turkey in a pan;

FIG. 27 shows a grill on which a two-tier cooking and basting device is placed on a turkey that sits directly on the grill rather than in pan;

FIG. 28 shows a commercial smoker wagon on which multiple two-tier cooking and basting devices are placed on turkeys;

FIG. 29 shows another commercial smoker in which multiple two-tier cooking and basting devices are placed on turkeys;

FIG. 30 shows a pellet stove in which a two-tier cooking and basting device is placed on a turkey.

### DETAILED DESCRIPTION OF PREFERRED EMBODIMENTS

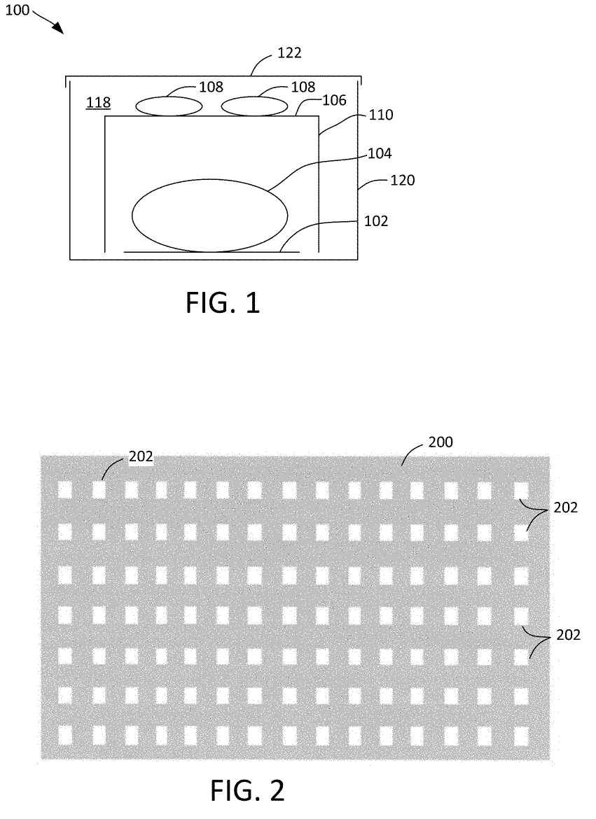

FIG. 1 schematically shows a cooking apparatus 100 that includes a lower cooking surface 102 for supporting one or more first food items 104, an upper cooking surface 106 for supporting one or more second food items 108. Upper cooking surface 106 is supported above the lower cooking surface 102 by a support structure, such as legs 110. The support structure may be formed integrally with the upper cooking surface 106 or may be mechanically attached thereto. All components are made from a food-grade material. All of the items can be enclosed in an optional cooking space 118 defined by a housing 120 having a lid 122. Lower cooking surface 102 can comprise the bottom of the housing 120 or lower cooking surface 102 can be a separate support surface positioned on or above the bottom of housing 120. Housing 120 can comprise, for example, a turkey roasting pan or a barbecue grill. Upper cooking surface 106 is positioned sufficiently high to allow space for food item 104 and sufficiently low to allow space for food items 108 between upper cooking surface 106 and lid 122.

Legs 110 can be supported on the bottom of housing 120 and straddle the first food items 104. Alternatively, legs 110 can be supported on the sides of housing 120, or by the first food item 104, either penetrating the first food item 104 with shape ends or resting on top of it, thereby being indirectly supported by the bottom of housing 120. The legs 110 may also be pinned to and be supported by the first food item 104 by means of pins attached to the legs 110. If the legs are formed integrally with the upper level cooking surface 106, said legs may be punch-out legs that can be separated manually before use of the cooking and basting apparatus, thus making manufacture simpler and reducing costs. In some embodiments, the support structure may not use legs at all and may comprise, for example, a ledge or lips on the housing 120 to support the upper cooking surface 106.

Upper cooking surface 106 includes perforations (not shown) to allow drippings from the food item 108 to drip onto food item 104. The perforations are sufficiently small so that food items 108 do not fall though the perforations while sufficiently large that dripping from food item 108 flows through the perforations. The shape of the perforation may be, for example, round, square, slot-form or irregular. The length of the perforation preferably does not exceed 1.25 inches and the minimum dimension of the perforations is no less than 0.125 inches.

The perforations can be arranged in parallel or staggered rows, and are preferably spaced close enough together that drippings from the second food item 108 drip down onto the first meat directly, without pooling in the spaces between perforations. The total open area of the perforations can be between 4% and 50% as long as the aforementioned conditions are met. In this way, the upper cooking surface 106 acts as a sieve or sifter to allow the melted fat and other basting liquids to separate from the source foods and drip down onto the first meat placed on the lower cooking surface.

FIG. 2 shows an example of a perforated platform 200 having square holes 202 aligned in regular rows.

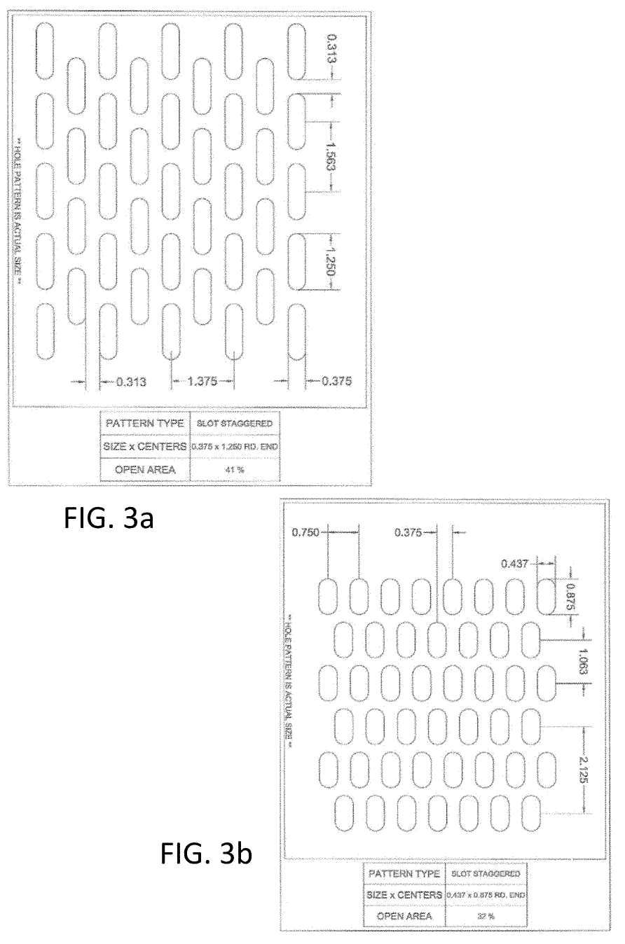

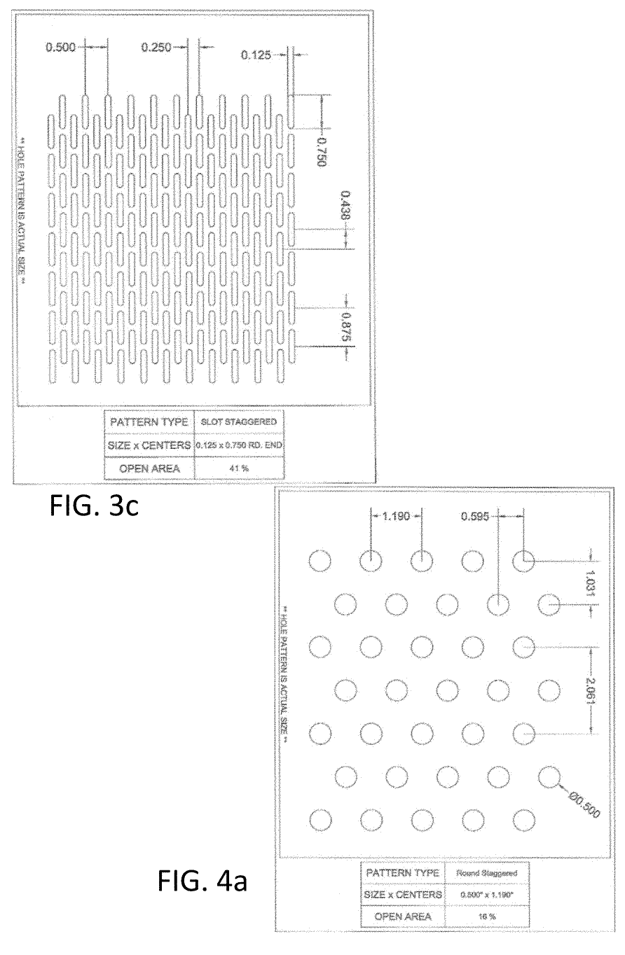

FIGS. 3-5 show a series of favorable configurations of the perforations in the perforated platform. FIG. 3a-c show slot-shaped perforations arranged in staggered patterns. In FIG. 3a, the perforations have a width of 0.375 inches and a length of 1.250 inches. The open area is 41% in FIG. 3b, the perforations have a width of 0.437 inches and a length of 0.875 inches, and the open area is 32%; and, in FIG. 3c, the perforations have a width of 0.125 inches and a length of 0.750 inches, and the open area is 41%.

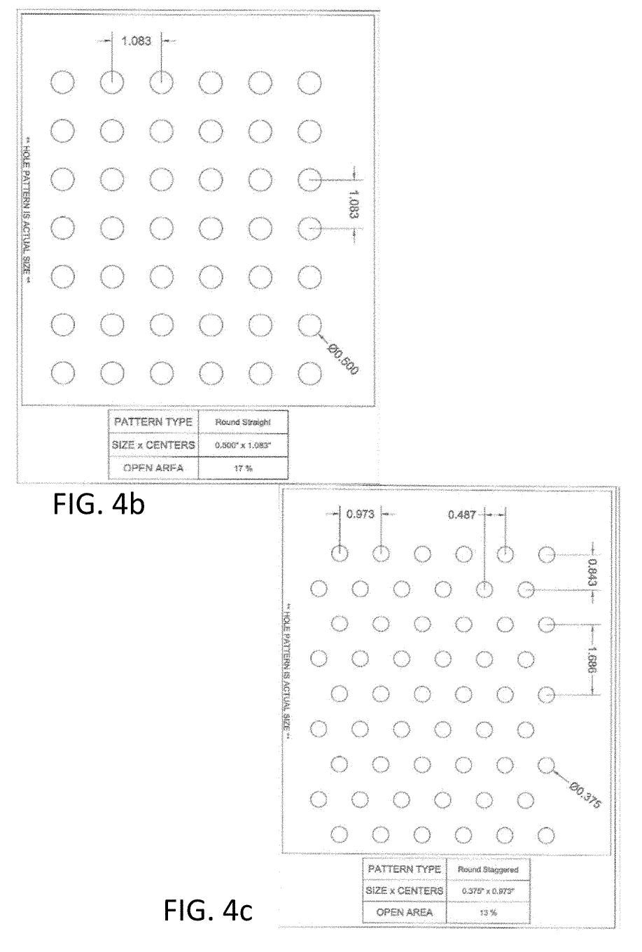

FIG. 4a-c show circular perforations arranged in staggered patterns (FIGS. 4a and 4c) and a straight pattern (FIG. 4b). In FIG. 4a, the perforations have a diameter of 0. 5 inches and the open area is 16%; in FIG. 4b, the perforations have a diameter of 0. 5 inches, and the open area is 17%; and, in FIG. 4c, the perforations have a diameter of 0.375 inches, and the open area is 13%.

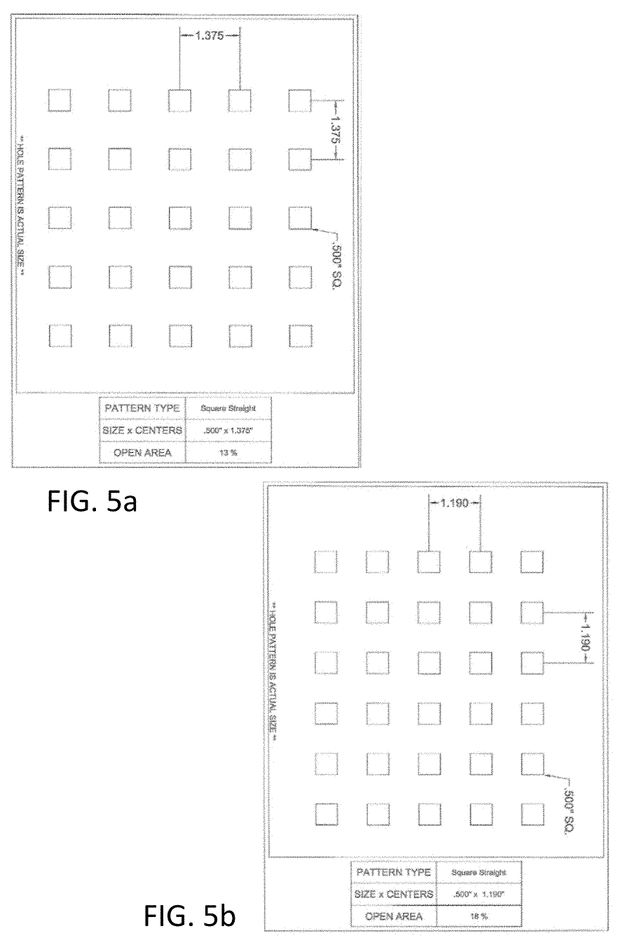

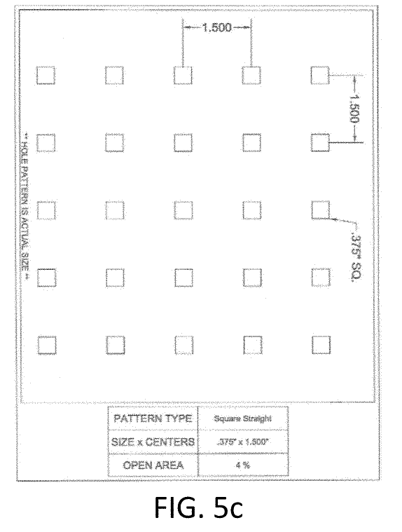

FIG. 5a-c show square-shaped perforations arranged in a straight pattern. In FIG. 5a, the perforations have a width and a length of 0.500 inches, and the open area is 13%; in FIG. 5b, the perforations have width and a length of 0.500 inches, and the open area is 18%; and, in FIG. 5c, the perforations have width and a length of 0.375 inches and the open area is 4%.

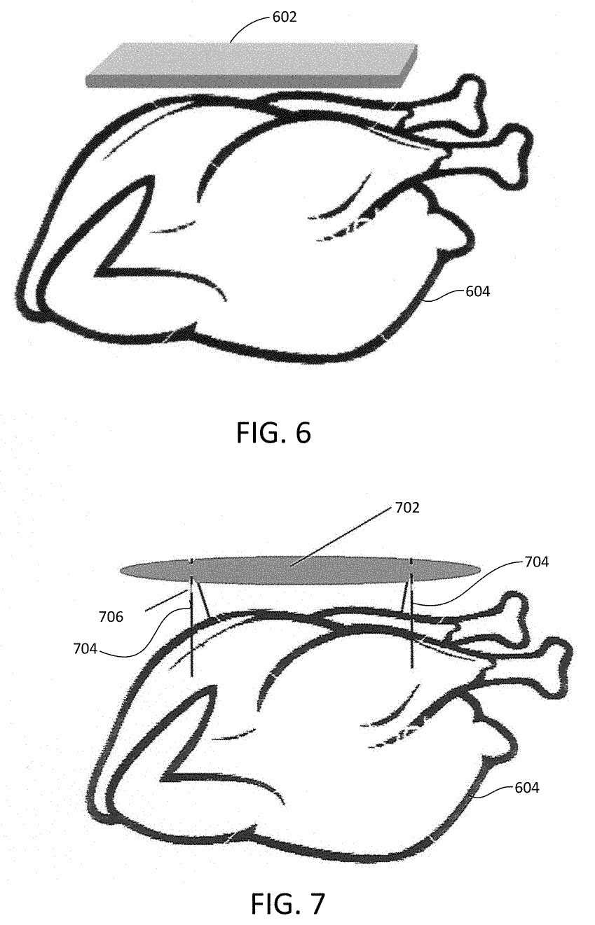

Upper cooking surface 106 may be any shape, for example, oval, rectangular, square or circular. FIG. 6 and FIG. 7 show examples of a rectangular upper cooking surface 602 and an ovular upper cooking surface 702, respectively, disposed directly above the first food item, which in this case is represented by a turkey 604. Both rectangular upper cooking surface 602 and upper cooking surface 702 have perforations, not shown. Upper cooking surface 702 is shown support on turkey 604 by supports 704, which can include thinner portions 706 to facilitate bending the support for adjustment. Supports for 702 include 4 legs, having a bending point.

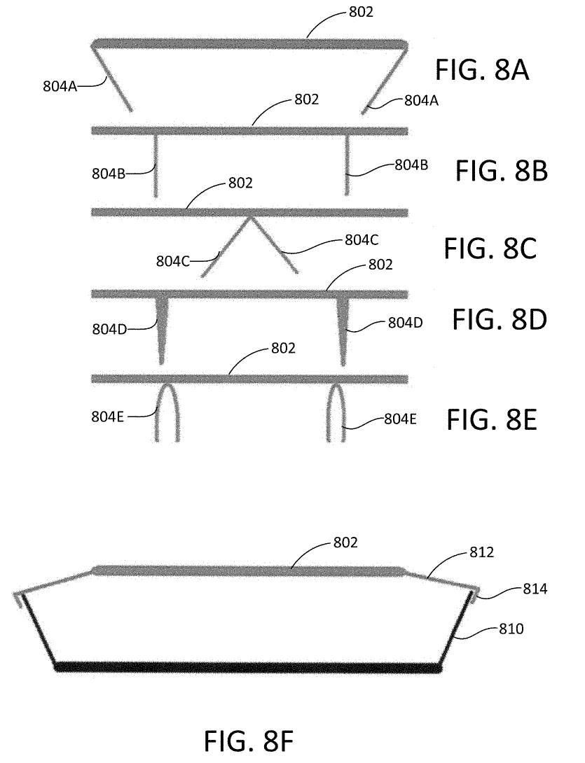

FIG. 8A-8F show example of various types of supports for upper surface 802. Supports 804A of FIG. 8A, are angled inward from the ends of upper surface 802. Supports 804B of FIG. 8B extend perpendicular to upper surface 802. Supports 804C of FIG. 8C extend at an angle from a point in the center of upper surface 802. Supports 804D of FIG. 8D extend perpendicularly from of FIG. 8D, with the end attached to support 802 being thicker than the distal end. Supports 804E of FIG. 8E include two-prongs. FIG. 8F shows upper cooking surface 802 supported on housing walls 810 by supports 812 which extend from cooking surface 802. Lips 814 extend from supports 812 and are bent over the walls 810, which secures the upper cooking surface 802 onto housing walls 810 angled over the housing walls 810.

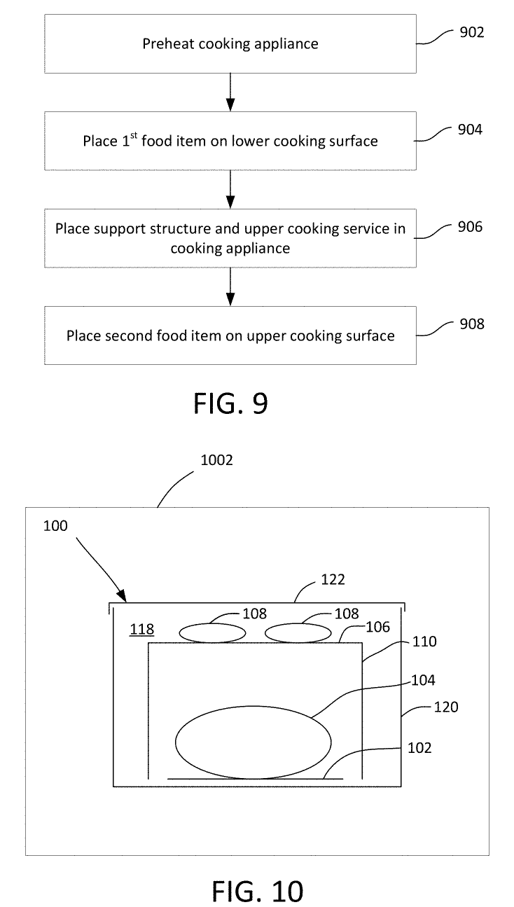

FIG. 9 is a flow chart 900 showing the steps of using the basting system. In step 902, heat is applied to preheat a cooking appliance. In step 904, a first food item operation having a first fat content is placed on a lower cooking surface within a cooking appliance. One or more first food items may be, for example, chicken, turkey, pork, beef, lamb or similar meat. In step 906, a support structure and upper cooking surface are placed in the cooking appliance. For example, the upper cooking surface may be a perforated platform and the support structure may be downwardly extending supports that rest on the first food item or on the lower cooking surface. In step 908, one or more second food items 108 are placed on the upper cooking surface. For example, the second food item may be meat, such as bacon or sausage, having a second fat content, higher than the first fat content. Alternatively, a food source that releases or exudes a seasoning substance such as oils or juices may be placed on the upper support surface instead of, or in addition to, the second meat. Such food sources may include onions, herbs (e.g. rosemary), garlic, slices of lemon or another citrus fruit, zest of lemon or another citrus fruit, jalapeno peppers, etc., making it possible to baste with a meat and additional seasoning foods. Alternatively, heat can be applied to the cooking appliance after the food items and the support structure are added. This saves energy by not requiring the cooking apparatus to be opened if it is hot.

FIG. 10 shows schematically cooking apparatus 100 of FIG. 1 placed inside of an oven 1002 that provides the heat source for heating. Housing 120 can comprise, for example, a turkey roasting pan that is sized to fit within a residential or commercial cooking oven. In this embodiment housing 120 with lid 122 preferably fits with a space of 36 inches wide ×27 inches high and 24 inches deep.

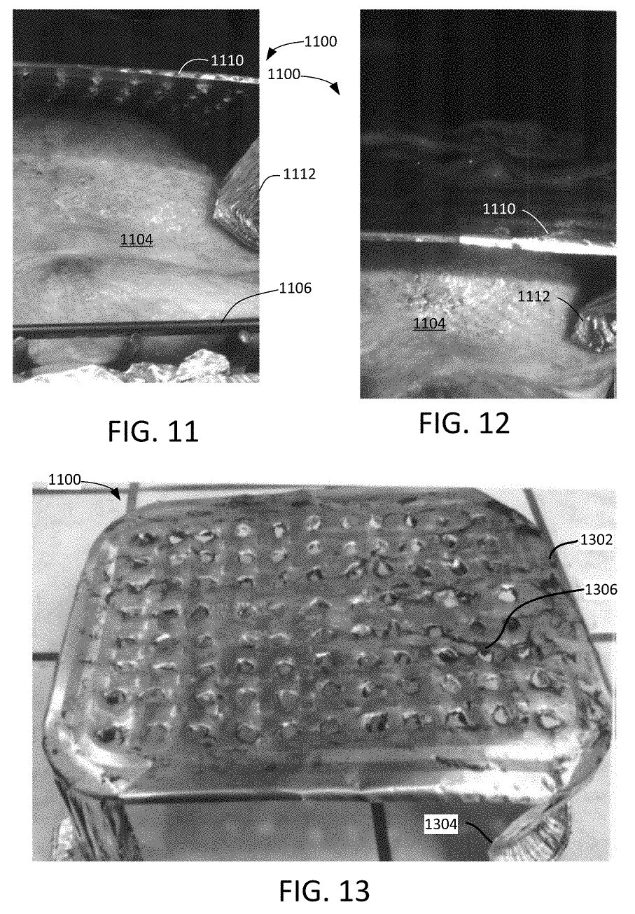

FIGS. 11, 12 and 13 show a cooking apparatus 1100. FIG. 13 shows a perforated surface 1302 used as an upper cooking surface, and the lip 1304 protruding downwards at the corners to support the perforated surface 1302. Perforations 1306 allow juices from the food item on top of perforated surface 1302 to drip onto the food item below, e.g., a turkey 1104. In FIG. 11, the turkey 1104 (corresponds to the first food items 104) is supported by an oven rack 1106 (corresponds to the lower cooking surface 102) and FIG. 11 further shows the perforated surface 1110 corresponding to upper cooking surface 106 arranged above the turkey and supported on the turkey by supports 1112. FIG. 12 shows another view of the apparatus in which a second food item 108 is visible and is supported on the perforated surface (upper cooking surface 106). If turkey 1104 is placed directly on oven rack 1106, a pan (not shown) can be positioned below the turkey 1104 to catch dripping. Alternatively, the turkey can be placed in a pan on oven rack 1106.

In FIG. 13, it can be seen that the support structures 1304 (corresponds to the legs 110) protruding downwards from the perforated surface 1302 are supported directly on first food item 104. In fact, several configurations are possible as support structures in this embodiment, as illustrated by FIGS. 8A-8F. The downward protrusions 1304 can rest on the bottom of the cooking apparatus or on the food item located thereon, optionally penetrating or being affixed to the first food item for support. Perforations 1306 allow juices from a food item positioned on the perforated surface 1302 to drip onto the food item below.

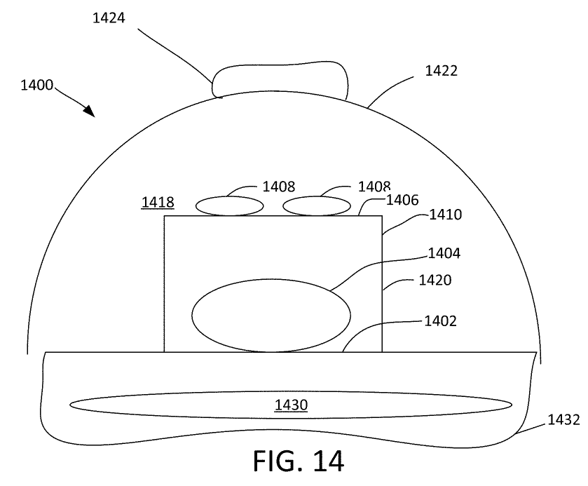

FIG. 14 schematically shows barbecue apparatus 1400 that includes a lower cooking surface 1402 comprising a barbecue grill surface for supporting one or more first food items 1404, and an upper cooking surface 1406 supporting one or more second food items 1408. Upper cooking surface 1406 is supported above the lower cooking surface 1402 by a support structure, such as legs 1410. All of the items are enclosed in cooking space 1418 defined by a barbecue grill 1400 having a lid 1422 with handle 1424 and a heating element housing 1420 that houses a heating element 1430 such as cooking charcoal or alternatively an electric heating element within a base 1432. Lower cooking surface 1402 in this embodiment is a barbecue grill that allows the first food items 1404 to be cooked by heat from the heating element 1430.

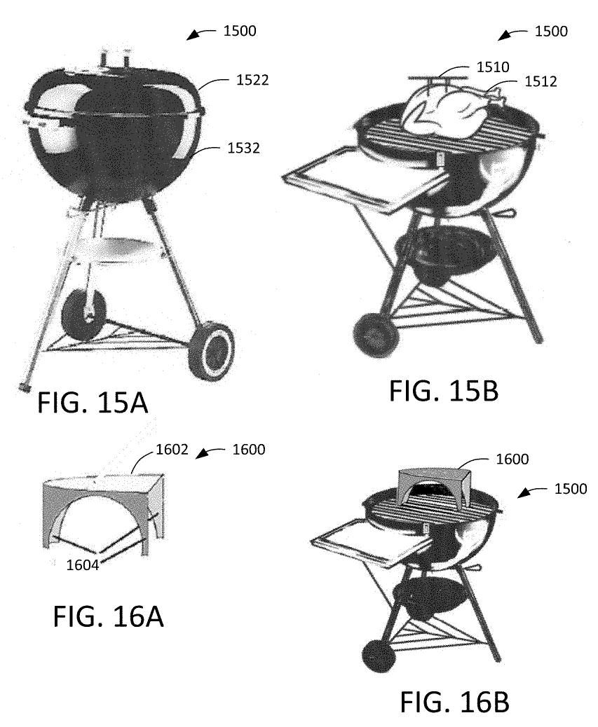

FIG. 15A shows an example of barbecue grill 1500 in which lid 1522 and bowl-shape heating element housing 1532 are visible. FIG. 15B shows the barbeque grill of FIG. 15A with the lid removed to reveal a turkey 1512 on which is positioned a two-tier cooking and pasting device 1510. Additional food items (not shown) would be positioned on the top surface of device 1510.

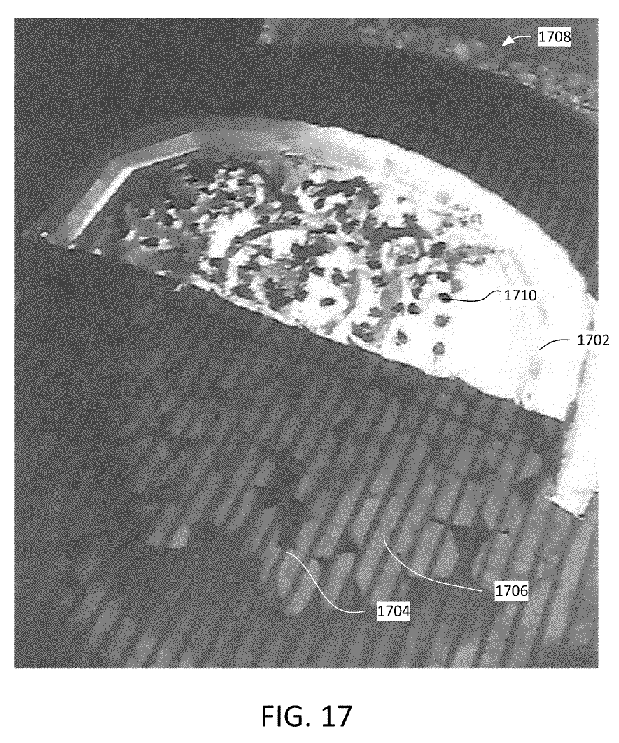

FIG. 16A shows another cooking device 1600 having a perforated upper cooking surface 1602 and supports 1604, preferably configured from aluminum, to be placed over a lower cooking surface (not shown). The supports 1604 are preferably form an integrally formed support structure extending downwards from the edges of said upper cooking surface 1602. FIG. 16B shows the cooking device 1600 positioned on a barbeque grill 1500. That is, the lower cooking surface is the grill surface of barbecue grill 1500 which is heated by burning charcoal (not shown). FIG. 17 shows a perforated surface 1702 made from aluminum foil having holes 1710 positioned above a grill surface 1704 above the coals 1706 of a barbeque grill 1708.

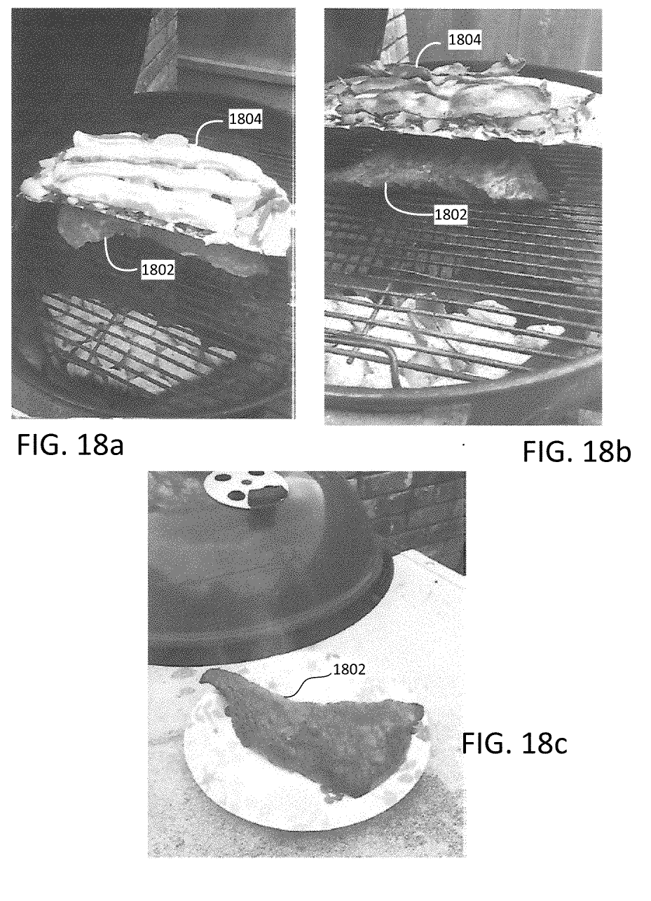

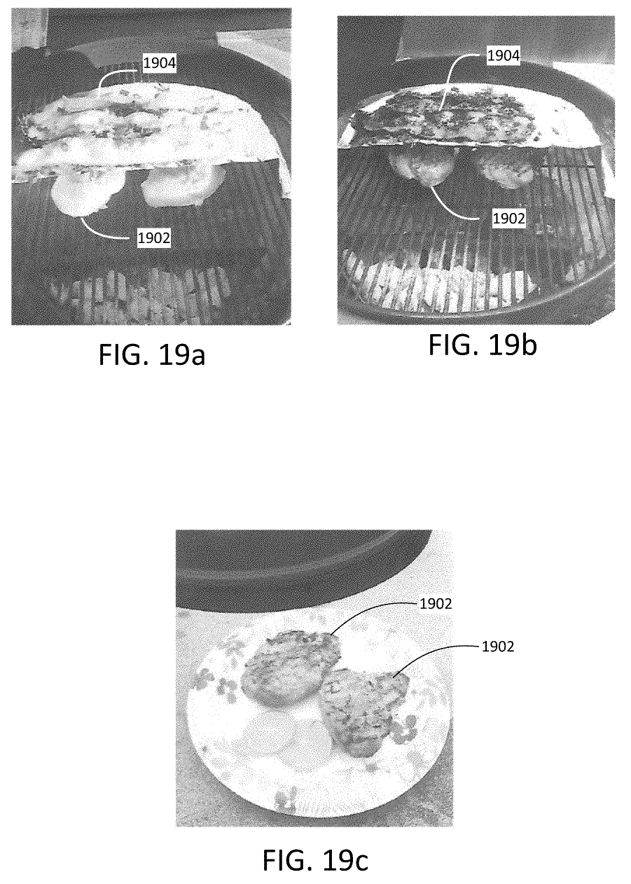

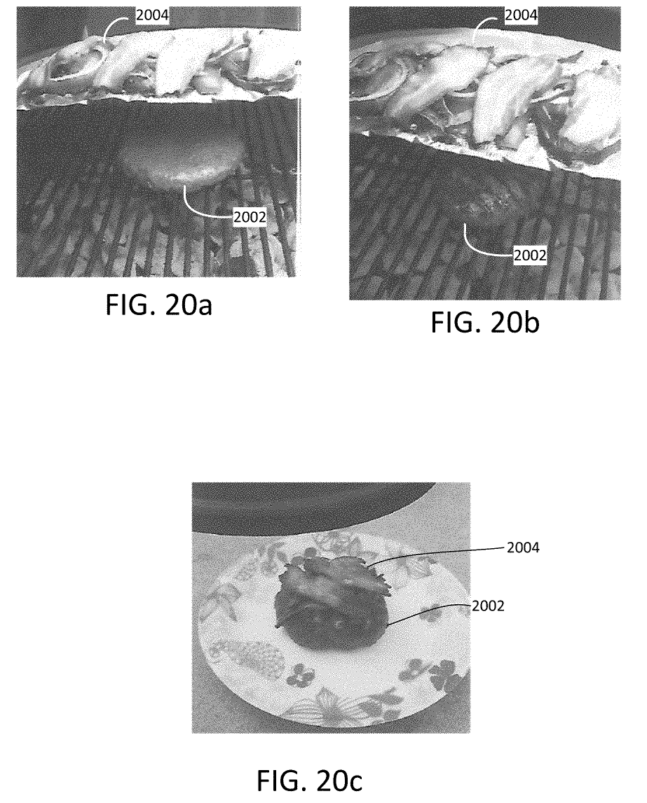

FIGS. 18, 19 and 20 show examples of use of this embodiment. Specifically, FIG. 18a-c show the case in which the first food item 1802 is a piece of steak, and the one or more second items 1804 comprise bacon, a meat with high fat content, and peppers. FIG. 19a-c show the case in which the one or more first food items consists of two pieces of chicken meat 1902, and the one or more second items comprise bacon 1904, a meat with high fat content, and onions and garlic. FIG. 20a-20c show the case in which the first food item is a hamburger patty 2002, and the one or more second items comprise bacon 2004, a meat with high fat content, and peppers and onions. In all three cases, during the cooking process, drippings that are exuded from the one or more second food items drip through the perforations in the second cooking surface onto the first food item, basting said first food item during the cooking process.

Embodiments of the invention provide a method and apparatus that enable the 100% self-basting of meats from top to bottom without the need to repeatedly baste the meat manually and open an oven door during the cooking process. This cooking apparatus provides for cooking multiple food items together, with drippings from second food items basting first food items positioned below the second food items. The apparatus can be incorporated into various cooking apparatuses, such as a conventional oven, a turkey roasting pan, or a barbecue grill. The second food items are placed upon a perforated platform, which is used to separate the juices and fats (“drippings”) from said food items such that the flavors therefrom to be distributed to and imbued in food items placed underneath the platform on a lower level.

In some embodiments, the cooking device includes a support portion that protrudes downwardly to support the perforated platform. These downward protrusions can be affixed to or separate from the perforated platform to provide support. The downward protrusions can be design as to rest on the bottom of the cooking apparatus or on the food item located thereon, in a variety of different ways (affixed, frictionally, penetrating, or simply resting thereon). Examples of configurations of the downward protrusions are illustrated in FIG. 8. The supports can be designed to support the perforated platform at a height so as to accommodate a food source to be placed underneath the perforated platform. By placing a food source on the perforated platform, the juices, fats and flavors exuded in the cooking process can drip down onto the other food items disposed below the perforated platform. The perforated surface can also be supported on the side of a cooking container. Protrusions can also extend in other directions, for example, they can extend upward to suspend the perforated platform from a higher structure, such as the top of the wall of a cooking apparatus. Or the protrusions an extend sideways to be supported by the walls of the cooking apparatus.

The perforated platform defines an upper level and the support surface that supports the lower food defines a lower level. In some embodiments, the perforated platform is designed as to cover a significant portion of the upper level with a wide variety of geometrical shapes (circular, half circular, square, rectangular, etc.).

The placement of items on the upper tier of the two-tier cooking apparatus allows for an endless array of flavors to be added to the food being cooked on the lower level. With the two-tier cooking and basting apparatus positioned directly above the food source to be self-basted (100%) with a great many flavors. Not only does it allow for self-basting of meats it also saves energy. By eliminating the need for manual basting, the oven door need not be opened for the basting process, thereby preventing heat loss. Thus, the two-tiered cooking and basting apparatus will therefore save energy.

A wide variety of foods, including as bacon, sausage, citrus and an endless variety of herbs, may be used as the source of the drippings. Other food items that can be used in the upper include chives, oregano, thyme bacon, peppers, onion, orange, sausage, garlic, lemon, and rosemary. One of the most common meats that is basted is turkey. The cooking device would also allow for the use of the often-discarded excess fatty meats/fats that are commonly trimmed off meats such as poultry, beef and lamb prior to cooking, etc. These fatty meats/fat can be placed on top of the perforated platform and while being cooked would allow foods on the lower level to be basted in their own juicy flavors from top to bottom during the entire cooking time. Thus, as a result, embodiments give real meaning to the phrase ‘100% self-basting’.

Some embodiments of the apparatus create a separation point or filter for separating the liquids and oils from a food source placed thereon. This allows the fats from a fatty food source (bacon, sausage, etc.) to be utilized in flavoring of a food item below. In some embodiments, excess fats trimmed from the meats on the lower level prior and can be placed on the perforated surface so to render the juices and fats form such in the cooking process to add enhanced flavors to the meat.

Embodiments of the invention allow for filtering out liquids and oils from herbs used in the cooking process so that the flavors of such can be utilized to flavor a meat or other food item below. Citrus, such as lemons, limes, oranges, etc., can be used in the cooking process to separate the liquids from them so that they can be utilized in flavoring of a food item. The zest of a citrus (lemons, limes, oranges, etc.) can also be used in the cooking process so that the oils can be separated to be utilized in flavoring of a food item.

The perforated platform provides a secondary cooking surface that sits above a primary cooking surface below. In some embodiments, the upper cooking surface is typically positioned between 1 inch and 4 inches from the inside surface of the lid so as to allow the placement of a second meat or other food item on the upper cooking surface.

The perforated platform is preferably made of a food grade material such as aluminum, stainless steel, etc. A food is cooked on the perforated platform above another food source. A perforated platform in which the perforations are as such the drippings from the food source being cooked on top can drip through to the food below but still retaining the food source on top of the perforated platform. The perforations can be of many geometric shapes, for example, circles, half circles, squares, rectangles, ovals, etc. In some embodiments, the perforated platform is designed to receive a separate downwardly supporting member for support by means of holes, notches, etc. In some embodiments, the perforations are elongated, that is, grill like, while still maintaining a spacing between each perforation that allows the juices from a food source to penetrate the platform and drip on the food below, yet still retains the food source on top of the platform. In some embodiments, the perforated platform is of a screen-like material. In some embodiments, the perforated platform covers a relatively large area of the upper level so that a greater number of different food sources can be cooked on its surface and their juices can penetrate through to a greater area onto the first level.

The legs or downward protrusions are made of a food grade material such as aluminum, stainless steel, etc. Downward protrusions may have many different shapes, such as round, square, rectangle, oval, etc. In some embodiments, downward protrusions may rest upon a surface below the perforated platform to support the perforated platform above. In some embodiments, downward protrusions may be constructed as part of the perforated platform. In some embodiments, downward protrusions have one or more support contact points with the surface below. In some embodiments, downward protrusions rest on a surface below with a continuous edge as a support contact point greater than or equal to the perforated platform circumference. In some embodiments, downward protrusions are made of and part of the perforated platform itself with a punch-out and push-down design so as to support the perforated platform. In some embodiments, downward protrusions penetrate the meat/food below as to support the perforated platform above. In some embodiments, downward protrusions are designed with a smaller diameter section to allow for bending of such protrusion for adjustment. In some embodiments, downward protrusions are made of a part of the perforated platform itself with a punch-out push-down design as to support the perforated platform with an additional pin that would pin such protrusions to the meat being cooked. In some embodiments, downward protrusions are a separate part of the perforated platform above but attaches to the platform so as to support the platform above the second level.

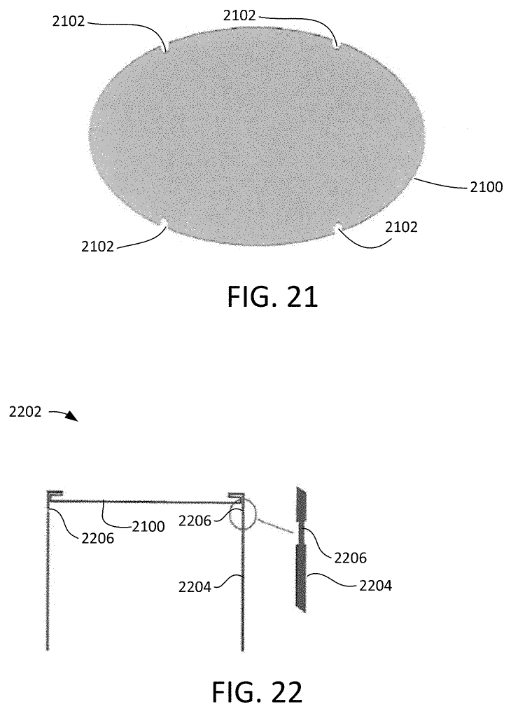

For example, FIG. 21 shows a perforated platform 2100 (perforations not shown) that has notches 2102 for attaching support legs (not shown). In some embodiments, downward protrusions are affixed to a surface below the perforated platform to support such platform. In some embodiments, downward protrusions frictionally engage a surface below the perforated platform to support such platform.

Downward protrusions can be made separately from the perforated platform and can attach to the platform using a notch on the platform. The downward protrusions are made with a section having a reduced width to provide a bending point for the protrusion for height and width adjustment of the perforated platform. These protrusions are made to contact or penetrate either the food item or a surface below the perforated platform.

FIG. 22 shows a two-tier cooking and basting apparatus 2202 in which the downward protrusions 2204 have a bending point 2206 to allow adjustment of the length, direction and orientation of the downward protrusions to allow accommodation of the perforated platform above the first food item and within the cooking space. The notches 2102 of perforated platform 2100 rest on the shoulder of bending point 2206 where the narrower portion of 2204 meets the wider portion. The top portion of 2204 can be bent over the perforated platform. With the perforated platform 2100 mounted on the support system using the notches 2102 on the perforated platform 2100, the downward protrusions 2204 then could be bent inward or outward for the width adjustment. The height adjustment of the platform then could be made with the depth that the protrusions penetrate the food source below.

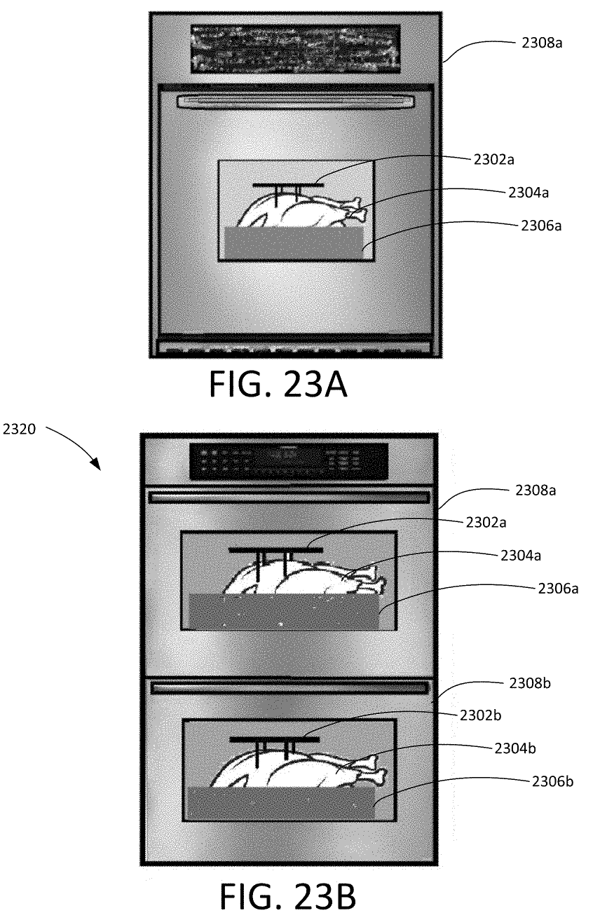

FIGS. 23A to FIG. 30 show examples of the versatility of the two-tier cooking and basting apparatus and how it can be adapted for the use in a great many cooking appliances. FIG. 23A shows two-tier cooking and basting apparatus 2302a supported on a turkey 2304a in a pan 2306a in an oven 2308a. A second food item (not shown), as described above, would be positioned on the upper tier of the two-tier cooking to drip juices or fat, i.e., to baste, the turkey 2304a. FIG. 23B shows a double oven 2320 containing, that includes the oven 2308a of FIG. 23A and a second oven, 2308b containing a second two-tier cooking and basting apparatus 2302b supported on a turkey 2304b in a pan 2306b. A second food item (not shown), as described above, would be positioned on the upper tier of the two-tier cooking to drip juices or fat, i.e., to baste, the turkey 2304b.

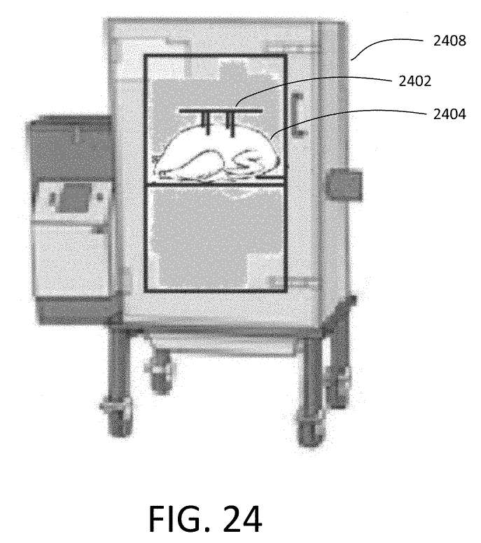

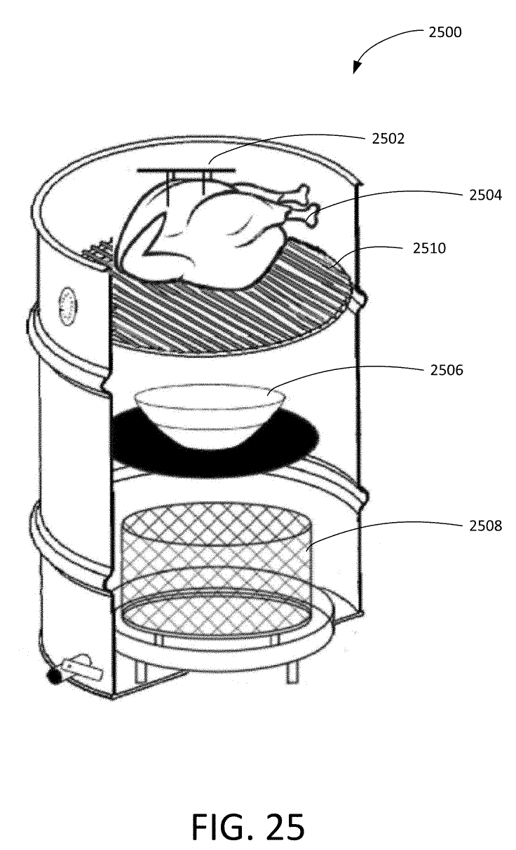

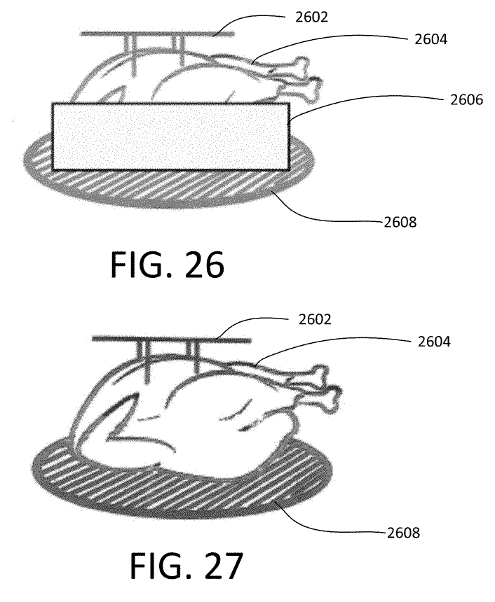

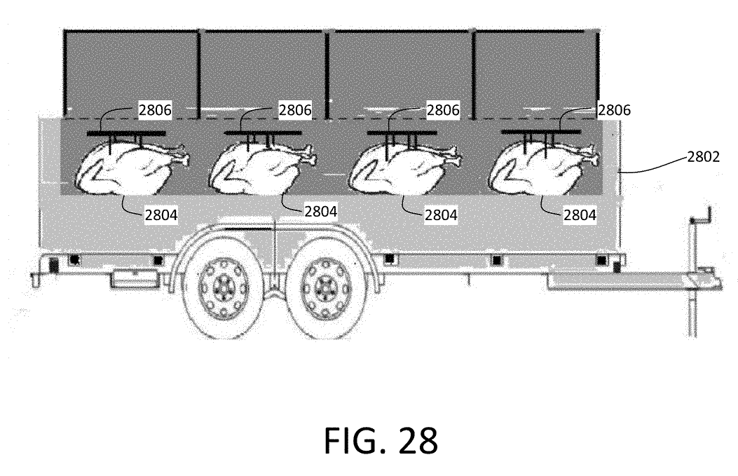

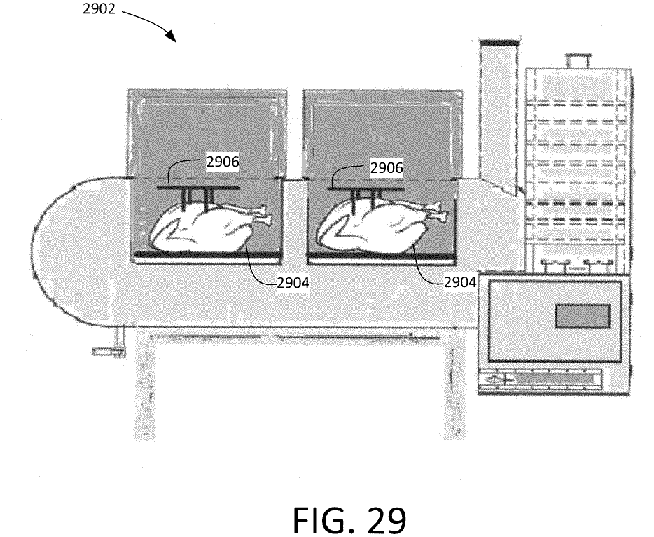

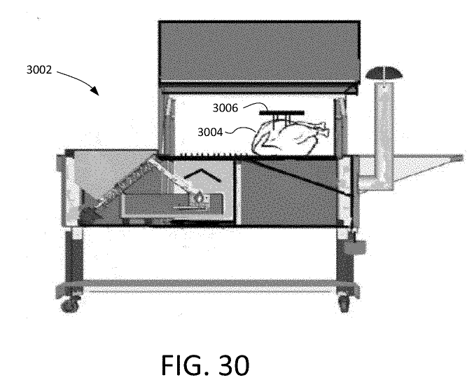

FIG. 24 shows two-tier cooking and basting apparatus 2402 supported on a turkey 2404 in an electric smoker 2408. A second food item (not shown), as described above, would be positioned on the upper tier of the two-tier cooking to drip juices or fat, i.e., to baste, the turkey 2404. FIG. 25 shows a barrel smoker 2500 containing a two-tier cooking and basting apparatus 2502 supported on a turkey 2504 positioned on a grill 2510. A bowl 2506 collects drippings from the turkey 2504. A cage 2508 contains the cooking fuel (not shown). FIG. 26 shoes shows two-tier cooking and basting apparatus 2602 supported on a turkey 2604 in a pan, 2606 on a grill 2608. FIG. 27 shows the turkey 2604 of FIG. 26 positioned directly on a grill 2608 without the pan. FIG. 28 shows a wagon mounted commercial smoker 2802 in which multiple turkeys 2804, each of which support a two-tier cooking and basting apparatus 2806. FIG. 29 shows another commercial smoker 2902, containing two turkeys 2904, each of which support a two-tier cooking and basting apparatus 2806. FIG. 30 shows a pellet stove 3002 containing a turkey 3004 supporting a two-tier cooking and basting apparatus 3006.

In some embodiments, the perforated surface and its support are made of aluminum foil, like disposable turkey pans material. Made with a punching and forming die machine that can produce perforations and smooth or wrinkled walls. Making a disposable and recyclable apparatus can be inexpensive and requires customers to purchase additional apparatuses. Such foil devices are inexpensive to manufacture. Little shelf space is required for display in stores, and the device is easy to use with simple instructions. The device simplifies the basting process of meats with a great many flavors during the cooking process. The food source cooked on top of the perforated platform of the cooking device becomes a great addition to the food cooked on the lower platform underneath in the way of condiments or additional side dishes. By adding spices, fresh herbs, lemons, limes, onions and peppers, etc., to the perforated platform, a great many flavors could be introduced to the meat below like poultry, beef, pork and lamb to name a few. A recipe booklet could be created and included as part of a kit that also includes the apparatus.

This cooking device saves energy. When basting a turkey conventionally with a manual turkey baster brush, spoon, etc., the oven door trust be opened repeatedly, resulting in considerable heat loss. Multiplied by the number of turkeys cooked annually in the US, the cost savings and environmental impact are considerable, given that, according to one estimate, 46 million turkeys are cooked on Thanksgiving, 22 million turkeys on Christmas, 19 million turkeys at Easter time, and a total of 200 million turkeys every year (statistics from National Turkey Federation, http://www.eatturkey.com/why-turkey/history).

Embodiment of the invention can provide many advantages over the prior art. Having a simpler structure than other automatic basters, does not use a separate energy source, is not prone to mechanical faults, can be easily manufactured at low cost and using recycled materials. Whereas in some prior art, the basting liquid must be prepared in advance, the invention of the present application makes it possible to cook the upper tier food item at the same time as cooking the lower tier food item and to baste the lower tier food item with the basting liquid exuded from the upper tier food source, thus saving a step in preparation and making cooking extremely convenient and viable for use in both non-professional as well as professional cooking.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

Accordingly, the appended claims are intended to include within their scope such processes, machines, manufacture, compositions of matter, means, methods, or steps.

We claim as follows:

1. A method of cooking meat, comprising:
placing a first meat having a first fat content on a lower cooking surface within a cooking appliance;
placing a perforated platform above the first meat;
placing a second meat having a second fat content, higher than the first fat content, on the perforated platform positioned above the lower cooking surface in the cooking appliance; and
heating the first meat and the second meat in the cooking appliance so that fat from the second meat drips down onto the first meat to baste the second meat,
wherein the perforated platform includes perforations sufficiently small so that the second meat does not fall though and sufficiently large so that fat from the second meat passes through the perforations and onto the first meat.

2. The method of claim 1, in which placing a perforated platform above the first meat includes placing a perforated plated platform including downwardly extending supports, and further comprising positioning the downwardly extending supports onto the first meat.

3. The method of claim 1, in which heating the first meat and the second meat in the cooking appliance comprises heating the first meat and the second meat in an enclosure space.

4. The method of claim 2, in which:
placing a perforated platform including downwardly extending supports includes placing a perforated platform including bendable downwardly extending supports; and
positioning the downwardly extending supports onto the first meat includes bending the downwardly extending supports to adjust the position of the perforated platform over the first meat.

5. The method of claim 4 in which placing a perforated platform including downwardly extending supports includes providing a perforated platform having notches and in which the downwardly extending supports are formed from the perforated platform and mate with the notches of the perforated platform.

6. The method of claim 1, in which placing a first meat having a first fat content on a lower cooking surface within a cooking appliance comprises placing a first meat within a barbecue grill or smoker.

7. The method of claim 1, in which placing a first meat having a first fat content on a lower cooking surface within a cooking appliance comprises placing a first meat within a roasting pan.

8. The method of claim 1, further comprising placing a food source that releases or exudes a seasoning substance onto the perforated platform in addition to the upper meat.

9. A cooking apparatus for cooking two meats simultaneously, one of the meats having a second fat content and being positioned to drip fat onto a first meat having a first fat content lower than the second fat content, the apparatus comprising:
a roasting pan having a lid, the pan and lid defining an enclosed cooking space, and the bottom of the roasting pan defining a lower cooking surface for supporting a first meat to be cooked;
an upper cooking surface within the enclosed cooking space for supporting a second meat to be cooked, the upper cooking surface situated directly above the lower cooking surface and having perforations sufficiently small so that meat placed on the upper cooking surface does not fall though the perforations while sufficiently large that melted fat from the second meat flows through the perforations; and
a support structure that rests on the bottom of the roasting pan and that supports the upper level cooking surface within the enclosed cooking space, the support structure including vertical legs that rest on the lower cooking surface.

10. The cooking apparatus of claim 6 in which the perforations have a maximum dimension of between 0.125 in and 1.25 in.

11. The cooking apparatus of claim 6 in which the upper cooking surface is positioned between 1 inch and 4 inches from the inside surface of the lid.

12. A cooking apparatus for cooking two meats simultaneously, one of the meats having a second fat content and being positioned to drip fat onto a first meat having a first fat content lower than the second fat content, the apparatus comprising:
a perforated platform for supporting a second meat to be cooked, the perforated platform positioned directly above a lower cooking surface for supporting a first meat to be cooked, the perforated platform having perforations sufficiently small so that meat placed on the upper cooking surface does not fall though the perforations while sufficiently large that melted fat from the second meat flows through the perforations; and
a support structure configured to rests on the lower cooking surface or on the first meat and that supports the perforated platform, the support structure including vertical legs that rest on the lower cooking surface or on the first meat.

13. The apparatus of claim 12 in which the support structure is configured to rest on the lower cooking surface.

14. The apparatus of claim 12 in which the support structure is configured to rest on the first meat.

15. The apparatus of claim 12 in which the perforated platform includes multiple notches and in which the support structure comprises individual legs, each of which mates with one of the multiple notches.

16. The apparatus of claim 15 in which the individual legs each have a reduced width portion that mates with a corresponding notch in the perforated platform.

17. The apparatus of claim 12 in which the perforated platform comprises aluminum foil.

18. The apparatus of claim 17 in which the support structure comprises aluminum foil.

19. The apparatus of claim 12 in which the support structure is permanently connected to the perforated platform.

20. The apparatus of claim 12 further comprising a heat source for cooking the food items.
